(19) United States
(12) Patent Application Publication
(10) Pub. No.: US 2014/0257953 A1
(43) Pub. Date: Sep. 11, 2014

(54) METHOD AND APPARATUS TO ANONYMOUSLY COMMUNICATE ENCRYPTED CONTENT BETWEEN MOBILE DEVICES IN PROXIMITY AND IN EXPANDED USER COMMUNITIES IN A CONTAGIOUS, VIRAL MANNER

(71) Applicant: VYRAL LIMITED LIABILITY COMPANY, HAWTHORNE, NJ (US)

(72) Inventors: David Todd Kaplan, Hawthorne, NJ (US); Alan Stuart Kaplan, Short Hills, NJ (US)

(73) Assignee: VYRAL LIMITED LIABILITY COMPANY, HAWTHORNE, NJ (US)

(21) Appl. No.: 14/202,160

(22) Filed: Mar. 10, 2014

Related U.S. Application Data
(60) Provisional application No. 61/774,610, filed on Mar. 8, 2013.

(51) Int. Cl. G06Q 30/02

(52) U.S. Cl. CPC G06Q 30/0214; G06Q 30/0277; G06Q 30/0261; G06Q 30/0269
USPC 705/14.16; 705/14.73; 705/14.58; 705/14.66

(57) ABSTRACT

An information dissemination method and apparatus facilitates transmission of information to primary receivers and re-transmission to secondary receivers using native mobile devices, without necessarily depending on friends lists or the internet. The chain of transmission “links” can be tracked and logged, and users in the chain can be rewarded for participating. The information, referred to as “germs,” can be generated, propagated and spread in a viral manner, wherein the germs are filtered and exchanged among users in close proximity, within a pre-registered user group, or through the internet. Embodiments can be used for one-to-one and one-to-many communications in the social media, advertising, and/or security industries, and do not require client-users to know each other or be on friends lists. Preference settings, rules, behavior tracking algorithms, semantic data analytics, and manual censorship can be individually or collectively utilized in the peer selection and filtered germ dissemination processes.

### RELATED APPLICATIONS

This application claims the benefit of U.S. Provisional Application No. 61/774,610, filed Mar. 8, 2013, which is herein incorporated by reference in its entirety for all purposes.

### FIELD OF THE INVENTION

The invention relates to methods for distributing information, and more particularly to viral communication methods.

### BACKGROUND OF THE INVENTION

Disseminating information and getting large audiences to consume it has been a significant problem for people and entities with a message to deliver since ancient times. Currently, when a person or company builds a website, or posts something to a blog, Facebook, YouTube, etc. almost always: a) no one knows; b) not many care; and c) only a few stumble upon it—because there is too much information out there, and attention-getting techniques like Public Relations campaigns, cross-promotions, and search engine optimizations are all expensive options, which are hit-or-miss in their effectiveness.

The current state of information distribution is characterized by one-on-one online notifying, texting, emailing, and otherwise sharing activities, broadcast emails, and perhaps viral marketing, which is a persistent phenomenon that does desirable things like launch careers, inspire success stories, and afford some lucky people their 15 minutes of fame, or “buzz.” When content “goes viral” whether it is an entertaining YouTube video, Facebook page, or celebrity Tweet, etc., it is due to traditional communication techniques such as word-of-mouth, chatting, texting, emailing, radio or TV broadcasting, blog and viral website posting, etc., all of which are effected by deliberate, manual means.

Today, much of the non-broadcast human experience is shared via cellular communications, and web-based social media, including texts, emails, site remarks, and other forms of manually distributing comments with links to interesting content. Hence the term “going viral”, which analogizes the spread of information at rapid, uncontrolled, and even exponential rates like diseases infecting organisms, or malicious computer code. If content goes viral, millions online will likely view it. However, current technologies limit content sharing to manual distribution techniques over cellular broadband, or via the internet, and they require multiple deliberate efforts on the part of each participant, or the chain will be broken, which is neither automated nor virus-like at all. Therefore, current terminology like “viral sharing” and “viral marketing” erroneously imparts a contagious nature to the information that is independent of the actions of people, which is not present in the prior art.

In the prior art there is also Twitter, which lets the user broadcast small amounts of text to followers and has touted some little-used geographical ability. The application known as “We Chat” will allow text, voice, or video calls to members you know, and local members you do not know, who are in proximity to you, all of whom must accept an invitation before communications begin. However, no invention has combined semantic rules, taxonomies, ontologies, algorithms, preference settings and other decision support technologies, to appropriately match members to each other, and filter messages, which reduces or eliminates the main need for peer lists, including friends lists, professional associations, group memberships, introductions and acceptances, vouching and endorsing for proposed members, etc. Said lists and requirements have their place, but have held back social media and promotion advertisements, from becoming even more popular and utilized. Tagging tweets with location information has failed largely because not many people want their name associated with their location for all twitter followers. Hence the desirability of widespread dissemination and anonymity in the current method and apparatus.

In the prior art, like We Chat, Google has a system for users to locate each other, where the “Sending a first message to the first mobile device based on the proximity of the first user to the second user, wherein the first message identifies the location of the second user; and sending a second message to the second mobile device based on the proximity of the second user to the first user, wherein the second message identifies the location of the first user.” (U.S. Pat. No. 7,593,740, Crowley et al). This occurs through a connecting and mediating computer server, on a one-to-one basis, with no peer-to-peer interconnectivity

The streaming of video content from Netflix, which is a service that makes well-informed movie suggestions to its subscribers based on the ones ordered in the past and other behavioral algorithms. They ran a contest for the best of such filters, and the outcome is a system of highly-useful behavior rules and algorithms, the likes of which are incorporated in, and will provide benefit to the current invention's effectiveness, when combined with the apparatus and method disclosed herein.

Foursquare and others create advertising revenue, and have been described as “Targeting content and advertising based on a user's location, through a downloaded app, via social media or a publisher's own website, which provides opportunities to drive new levels of customer engagement, along with new revenues. The effect of location-based technology will be invaluable to the publishing industry as a means of delivering geo-based content and advertising.

The world of advertising and marketing has envisioned and experimented with location-based campaigns to sell products and services, with in-store, and nearby promotion notifications to those who have the respective app on their smartphone, tablet, smart-watch, etc. The goal is to direct a consumer to a retail establishment and get them to buy the goods and services for sale on the premises, thereby getting them to spend money before they leave. There are also apps that a nearby retailer can use to directly announce, one-to-one, who they are, and perhaps give timely offers of discounts or extra value, as a user passes by, as long as the recipient has requested to receive such solicitations from that particular advertiser.

Downloadable applications for sharing information at events, such as the smartphone app a user can download at Madison Square Garden, currently help audience members communicate with each other for location and entertainment value and with security personnel for safety. However, expensive infrastructure and software in a physical location (building, arena, etc.) are required for this security and entertainment feature to function.

What is needed, therefore, is a method and apparatus for disseminating information in a “viral” manner, while tracking the “chain” of information transmissions, providing motivation for users to participate in the dissemination, eliminating dependence on “friend lists,” providing anonymous transmission, providing encrypted transmission, and/or automatically re-transmitting the information among the users.

### SUMMARY OF THE INVENTION

An information dissemination method and apparatus facilitates transmission of items of information, referred to herein as “germs,” to primary receivers, and re-transmission of the germs from the primary receivers to secondary receivers, without necessarily depending on friends lists or on the internet. In embodiments, the chain of transmission “links” is tracked and logged, and the users in the chain can be rewarded for participating in the transmission. In some embodiments, the information is propagated in a viral manner, wherein the germs are filtered and automatically exchanged among users in close proximity, within a pre-registered user group, or to the internet. Embodiments can be used for one-to-one and one-to-many communications in the social media, advertising, and security industry sectors, and do not require client-users to know each other or be on friends lists. Preference settings, rules, and behavior tracking algorithms can be combined into the filtered germ-swapping process.

In embodiments the present invention is a location-based, information sharing method and apparatus that facilitates local transmission and viral dissemination of information using native mobile computing devices with a mechanism to do this that does not necessarily initially depend on the internet. The apparatus and method enable the generating, propagating, automatic spreading, and tracking of encrypted items of information in a manner that mimics how organisms and computers contract and spread viruses, thereby enabling “viral sharing”, “viral marketing”, and “viral selling”. In embodiments, a tracking feature enables the sender to know which member passed which germ to other members, and when promotional messages are involved, rewards for manual and auto-resending of commercial offers can be given. Various embodiments of the invention are used for one-to-one and one-to-many communications in the mobile social media, neighborhood promoting, location-based advertising, and onsite physical security industry sectors, and do not require client-users to know each other, accept invitations from each other, or be on friends lists. Rather, like a reverse search engine, messages containing information reach out to anonymous users, with like interests.

The invention spreads information in a more virus-like way, by means of a one-to-one exchange of “contagious” germs between client-users in proximity to each other. In embodiments, users can set preferences as to what types of germs can be made contagious, meaning auto-resent, and thus have a greater chance to spread the germs manually or automatically in a truly viral-like manner. In various embodiments, germs can be transmitted automatically to 1) others in proximity, 2) by means of private communities or user-groups anywhere, and 3) over a network such as the internet to reach the greatest possible number of listeners, viewers, consumers, event attendees, and security administrators, etc.

The present invention is specifically designed to spread items of content (referred to herein as “germs”) in this above-described, virus-like manner, such that the invention aids in the chances for a viral success when spreading interesting information, such as video clips, games, eBooks, brandable software, images, text messages, or any web page someone has deemed “worthy enough” to be shared. In embodiments, the present invention further incentivizes users to do so, when advertisers and promoters reward them, not only for buying, but also for spreading the information to others who make purchases.

In embodiments, sharing of germs can be synchronized, whereby the invention server can stream content such as music, lessons, or videos to multiple users who had not previously known each other as group members with like tastes and interests, classmates, etc. The result, in these embodiments, can be described as being similar to listening to a virtual boom box carried by someone passing nearby, or watching a show as an anonymous nearby or distant audience member of a virtual theater audience.

Embodiments of the present invention do this while using high-levels of encryption, similar to those used in online banking transactions, which affords client users the opportunity to exchange communications that cannot easily be hacked. Other social media systems, with or without location-based features, work on a friend or member list where agreement is needed to share certain levels of information, like Facebook, LinkedIn, Twitter, etc. Anonymity is further enhanced with said encryption capability.

Embodiments of the present invention enable a neighborhood, or nearby retailer, to announce their presence and other information to client users that are passing by, functioning like a virtual billboard, or virtual loud speaker. Advertisers can announce special offerings for a limited amount of minutes or hours, and may even compensate others who helped the customer reach their place of business, whereby the transfer of the first user's advertising germ was responsible for the second user's visit to the advertiser's premises, which can be determined by the location-based qualities of embodiments of the invention, in combination with the germ tracking capabilities that record which users passed which germs to which other users, all of which are stored in a file system, or database for analyzing and reporting purposes.

The nature of this invention lends itself to a higher level of location-based advertising and sales, whereby timed offerings can be disseminated virtually as if transmitted by a loud speaker, and/or advertised by billboard signs, and wearable/postable signs carried by individuals walking or driving nearby. And due to the anonymity of the transmissions, shy recipients-turned-advertisers, and others who are reluctant to offer recommendations, but here, are please to do so more openly, and in embodiments are motivated to do so by rewards they receive, within this anonymous commercial, and neighborhood-building context. In embodiments, a neighborhood and/or user-group administrator can act as a germ monitor, to augment the artificial intelligence, such as semantic filtering, and algorithmically derived preference list capabilities, included in embodiments and described herein.

Also, in embodiments, some germs require manual intervention, whereby some modifications are allowed, and as such, act as an override to pass on, or discard an otherwise filtered and removed germ.

Embodiments of the present invention enable one-to-one and/or one-to-many communication of germs, and can be used for example in the mobile communication, education, social media, advertising, security, and other sectors.

Embodiments of the present invention facilitate one-to-one and/or one-to-many sharing of items of information (“germs”) and virus-like contagion thereof for mobile devices via a server that tracks all client-users whose mobile devices are enrolled, and have the application turned on. In some of these embodiments the central server includes a rules-based engine that stores the germs that each client-user wishes to keep, as they are produced or received, in what is referred hereafter as a client-user's “pathology.” In some embodiments, a software or firmware-driven server keeps track of each client-user's location when possible using location features of the client user's computing device. It then controls the propagation process by mediating and forwarding the germs between willing participants, user-groups, and onto internet sites, thus facilitating a more virus-like spread of contagious germs that contain client-user-generated information. It then stores a record of who passed which germ to whom. In embodiments, user preference settings and profiles can be set and changed that enable the system server to auto-propagate. or filter content contained in germs. Extensive use of filtering is desirable to keep traffic down and reduce undesirable “spam” or inappropriate germs, such as offensive or heckling language, illegal drug selling, prostitution soliciting, etc.

In embodiments, the core algorithmic functionality of the present invention enables advanced collision detection, which enables the tracking of multiple client-users, be they in the hundreds, thousands, or more. An example of this is found in related co-pending U.S. patent application Ser. No. 14/180,568.

In various embodiments, a computing device such as a front-end administrative system enrolls, validates, notifies, and communicates with client users through a graphic user interface the pathology, and the plain text, hyperlink, and file attachment capability, downloaded into their mobile devices with the application, the mobile device's own text screen, and via email. Advertisers are signed up, billed, and assisted in this area. For premium users, in embodiments the front-end can handle pre-registered user groups, also called private communities, including enrollments and administration, billing, collecting fees, and notifying one or all. It can then facilitate the application of preferences, rules, behavior algorithms, etc., all of which determine what is contagious and to whom the germ spreads.

In the case of user groups, multiple locations can be in the germ-spreading area. For example, a user group of 1,000 soldiers could have a five mile radius around each of 54 military base locations, and advertisers to military personnel could reach them with promotions all simultaneously, or at staggered times across time zones.

In embodiments, the back-office administration comprises a secure database for enrollment, preferences, notices, account information, activities inside the application, external email notices, collection of fees, tracking of advertising commissions due, and other functions.

The world of advertising and marketing currently uses, envisions and embarks on innovative location-based campaigns to sell its products and services. The nature of the present invention lends itself to a higher level of advertiser-customer participation, with real-time transmission of germs that include offers that are timely, by the minute, hour, or multiple hours in a day, or multiple days in a week or month, in one or multiple locations. In embodiments, the proximity tracking device, and the records maintained on the server, keep track of what germs have gone to which client users and user groups, and can track and report who has soon thereafter redirected themselves to the advertiser's location after receiving a germ, presumably to take advantage of an advertiser's timely offer, enabling charges whereby advertisers can pay for actually getting client-users into the premises, or even a percentage of money spent by the client-user, as the advertising fee. Also, each client-user that allows an advertising germ to be contagious acts as if he or she is wearing a “virtual sandwich sign,” passing the germ on to other proximal client-users, who as a result may redirect themselves to the premises of the offering advertiser. In some of these embodiments, the client-user may receive a commission share, meaning a percentage of a set advertising fee for getting consumers into the location, or a percentage of the percentage the system-user gets for actual sales made. In some of these embodiments, the proximity system, the database design and implementation, and the back office administration can track and store all information needed to facilitate the aforementioned and other types of revenue-sharing, point rewards, and other incentivizing systems.

In various embodiments, the proximity-based system is also configured for private user-groups that share encrypted pictures, links, messages, alerts, etc. within an adjustable radius, within a campus, within multiple campuses, across a region, across the globe, or out to the world of client-users and internet surfers alike. This feature can be used for distributing items of information to families, friends, co-workers, organizations, etc., or as a social media tool that addresses private, security-conscious requirements. So as to increase event security, assist security service providers, assist surveillance teams, and/or assist law enforcement personnel, military personnel, etc., user-group administrators can download, install and set up embodiments of this application in pre-planned, or ad hoc, on-demand modes of operation, where other types of security communications systems that are not as secure, require installation, are not highly encrypted, are not as portable/mobile, are far more expensive, and are not nearly as practical. An entrepreneur can forward the same message to multiple employees, colleagues, customers, organizations, etc., with his/her name or as an anonymous sender/re-sender, better enabling the management of businesses by mobile devices.

It has been said that Twitter democratizes the generating and disseminating of news over the internet. The present invention goes even further: by democratizing the generation and mobile, location-based distribution of the local news, events, gossip, etc., and further distributes these messages over the internet, all without using a friends' or followers' list, and with the ability to do so anonymously.

Like an advanced form of tweeting, embodiments of the present invention can provide remote pathology utilization, sending and receiving germs from home, or anywhere the server designates. Even when a client-user travels, he or she may wish to check into the neighborhood germs that were left behind.

One general aspect of the present invention is a software implemented method for distributing and sharing information between peers. The method includes selecting a first group of peers to a first client user, enabling the first client user to transmit an item of information to the first group of peers using a computing device, the item of information being herein referred to as a “germ,” enabling said first group of peers to resend the germ using computing devices to at least one second group of peers, and logging the transmitting and resending of the germ.

In embodiments, the first group of peers is selected from among peers that are physically or virtually proximal to at least one location, the at least one location being at least one of a location of the first client user and at least one predetermined location.

In some embodiments at least one of the first group of peers and the second group of peers is manually selected by a client user or by a private community administrator who invites users to join the first group of peers or the second group of peers, where said user can accept or reject the invitation.

In other embodiments the first group of peers is selected from among peers in attendance at a multi-participant event, the germ including content that is able to enhance at least one of enjoyment and security of the peers in attendance at the multi-participant event.

In various embodiments, selecting the first group of peers includes using at least one of a mainstream vs. alternative lifestyle algorithm, a behavior algorithm, an internally selected business rule, a rule that is externally input, an automated artificial intelligence algorithm, semantic data analysis, a taxonomy, and an ontology.

In certain embodiments, the germ is filtered before it is resent, said filtering including at least one of manual filtering, physical or virtual proximity filtering, application of a mainstream vs. alternative lifestyle algorithm, application of a behavior algorithm, application of an internally selected business rule, application of a rule that is externally input, application of an automated artificial intelligence algorithm, application of semantic data analysis, application of a taxonomy, application of a preference list specified by a client user, and application of an ontology.

In embodiments, the germ is resent automatically to other peers. Some embodiments further include if the transmitting and resending of the germ accomplishes a desired result, whereby advertisers provide a reward the first resender, and/or to a chain of client users involved in the transmitting and resending of the germ.

In other embodiments the desired result is that a recipient of the germ makes a purchase from a specified merchant, and the reward includes at least one of a fixed fee paid by the merchant and shared among the chain of client users, a merchandise credit issued by the merchant and shared among the chain of client users, a percentage commission calculated based on a purchase price of the purchase, paid by the merchant, and shared by the chain of client users involved in transmitting the germ, and a merchandise discount offer distributed by the merchant to the chain of client users.

In certain embodiments, the germ is transmitted at least partly via a network. In various embodiments, the germ is resent manually. In some embodiments, the germ is resent automatically. And in various embodiments the germ is transmitted in an encrypted form that can be decrypted by peers on local devices.

In embodiments, at least one of the germ transmissions and resending is anonymous.

Another general aspect of the present invention is a software implemented method for distributing and sharing information between peers. The method includes automatically selecting a first group of peers to a first client user, enabling the first client user to disseminate an item of information to the first group of peers using a computing device, the item of information being herein referred to as a “germ,” and enabling said first group of peers to automatically resend the germ using computing devices to at least one second group of peers without user intervention, thereby distributing the germ among groups of peers in a contagious, viral manner.

In embodiments, the first group of peers is selected from among peers that are physically or virtually proximal to the first client user.

In some embodiments, selecting the first group of peers includes using at least one of a mainstream vs. alternative lifestyle algorithm, a behavior algorithm, an internally selected business rule, a rule that is externally input, an automated artificial intelligence algorithm, semantic data analysis, a taxonomy, and an ontology.

In other embodiments, the germ is filtered before it is resent, said filtering including at least one of physical or virtual proximity filtering, application of a mainstream vs. alternative lifestyle algorithm, application of a behavior algorithm, application of an internally selected business rule, application of a rule that is externally input, application of an automated artificial intelligence algorithm, application of semantic data analysis, application of a taxonomy, application of a preference list specified by a client user, and application of an ontology.

In certain embodiments, the first group of peers is selected from among peers in attendance at a multi-participant event, the germ including content that is able to enhance at least one of enjoyment and security of the peers in attendance at the multi-participant event.

Various embodiments further include logging the transmitting and resending of the germ and if the transmitting and resending of the germ accomplishes a desired result, providing a reward to at least one of the first client user, a first resender, a last resender, and an entire chain of client users involved in the resending of the germ.

In embodiments, the germ is transmitted at least partly via a network. In some embodiments, the germ is transmitted in an encrypted form that can be decrypted by peers on local devices. And in other embodiments at least one of the germ transmissions and resendings is anonymous.

Yet another general aspect of the present invention is a software implemented method for distributing and sharing information between peers. The method includes selecting a first group of peers to a first client user, enabling the first client user to transmit an item of information to the first group of peers using a computing device, the item of information being herein referred to as a “germ,” said first group of peers, and enabling said first group of peers to resend the germ using computing devices to at least one second group of peers, said second group of peers not being limited to pre-defined lists of peers.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram illustrating a Simplified System Configuration in an embodiment of the present invention;

FIG. 2 is a block diagram illustrating system participants, information exchange, and process flow for individuals in an embodiment of the present invention;

FIG. 3 is a block diagram illustrating system participants and process flow for advertising and security in an embodiments of the present invention; and

FIG. 4 is a block diagram illustrating that system participant views are like social media on the move in an embodiment of the present invention,

### DETAILED DESCRIPTION

An information dissemination method and apparatus facilitates transmission of items of information, referred to as “germs,” to primary receivers, and re-transmission of the germs from the primary receivers to secondary receivers, without necessarily depending on friends lists or on the internet. In embodiments, the chain of transmission “links” is tracked and logged, and the users in the chain can be rewarded for participating in the transmission. In some embodiments, the information is propagated in a viral manner, wherein the germs are filtered and automatically exchanged among users in close proximity, within a pre-registered user group, or to the internet. Embodiments can be used for one-to-one and one-to-many communications in the social media, advertising, and security industry sectors, and do not require client-users to know each other or be on friends lists. Preference settings, rules, and behavior tracking algorithms can be combined into the filtered germ-swapping process.

The invention can be used for peer to peer; peer to server; peer or peer mediator; peer or user group; and/or peer to the user group administrators (often security personnel). Additionally, the invention can be used as a server to the internet and/or the reverse, and/or peer-to-internet and/or the reverse, which are normal operating modes for a server and a mobile device, but are herein described and/or claimed because they are utilized to maintain the viral contagion of the present invention. The apparatus of the present invention uses at least one client and server that facilitates, notifies, and otherwise communicates with one or a plurality of clients to inform, alert or report.

In embodiments, the software of the present invention is adapted to run on any of a plurality of mobile computing device operating systems, and embodiments depend on the internet for its core functionality.

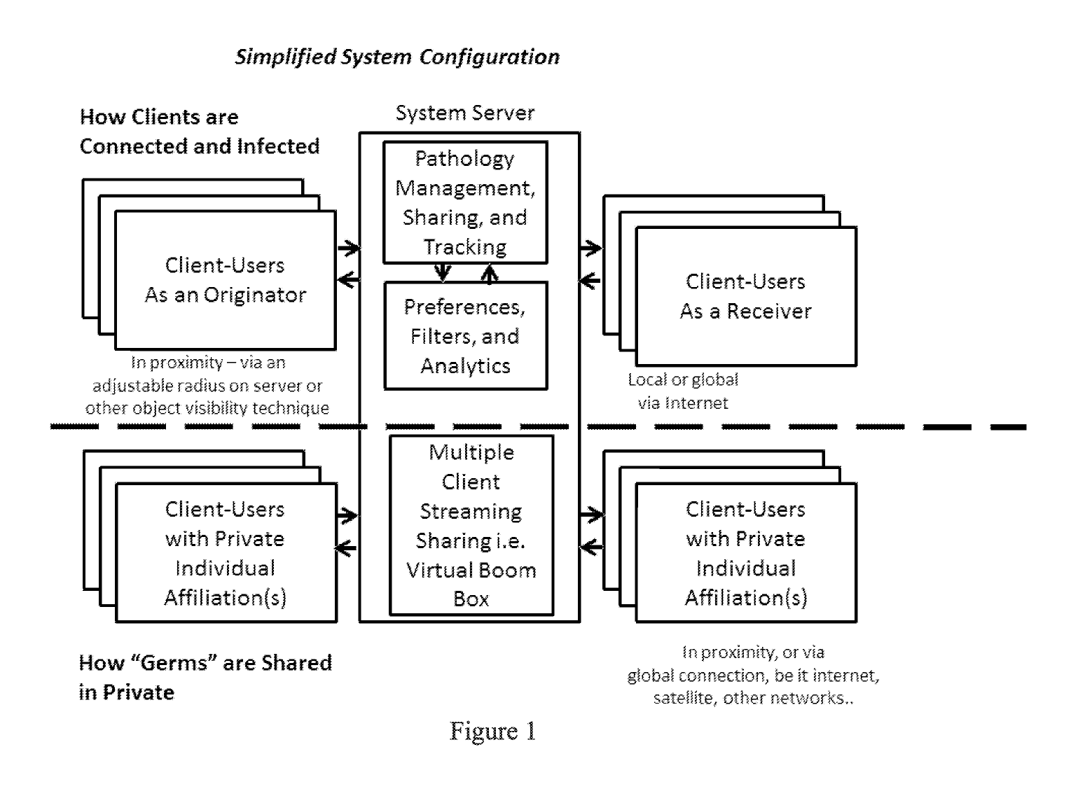

With reference to FIGS. 1-4, a client-user creates information packets, called germs, and has the ability to spread them to others. A list of germs stored in a user's mobile device is referred to herein as the user's “pathology,” which is the place or state of the germs where they are received, reviewed, rated, passed on, deleted, etc. A retransmitted germ can be spread to others, in proximity, in pre-designated areas operating like advertising or alert signs, in pre-designated areas' user groups, in multiple locations, and into the internet via a mediating server that records all actions taken and tracks all user locations.

In embodiments the server is flexible in design, and can accommodate a variable number of algorithms, employ a variable number of business rules that can be applied to technologies, preferences, and purposes of client users and technologies. In various embodiments, preferences and purposes of server administrators are facilitated through installed software and firmware code and data management applications and tool installations and updates.

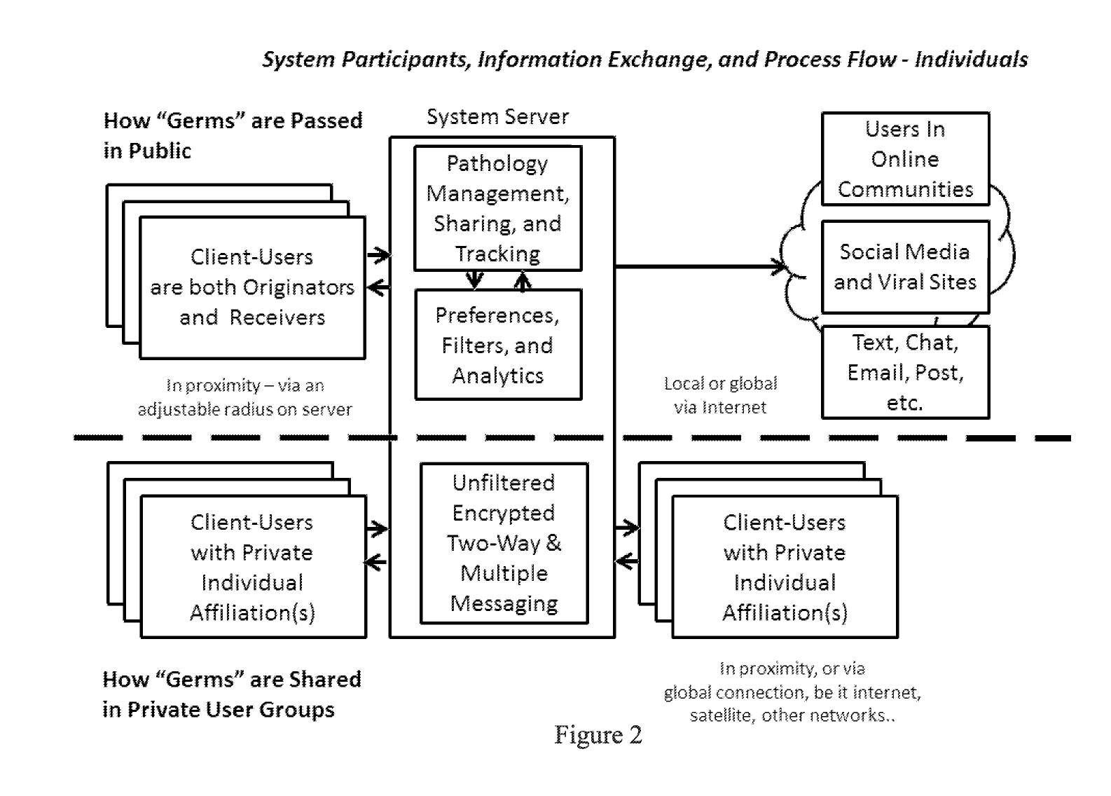

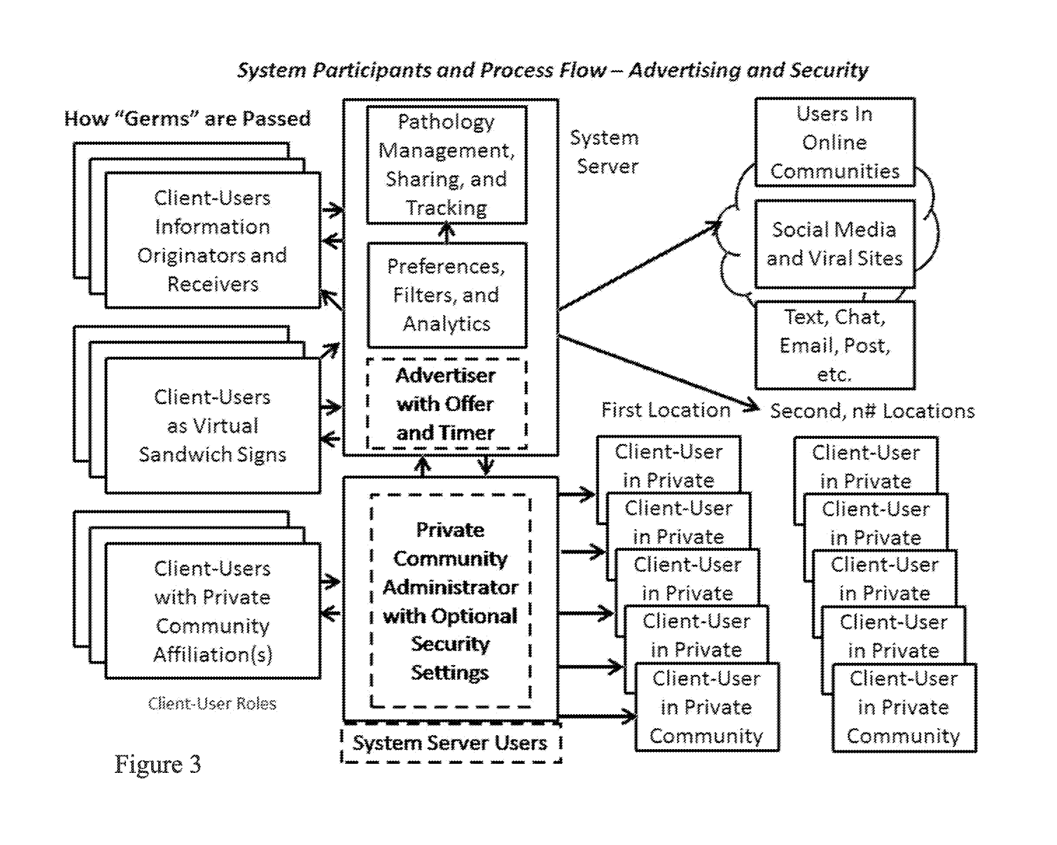

FIG. 2 is a block diagram that shows clients, server, internet sites, etc. and multiple campus configurations in an embodiment of the present invention. FIG. 3 is a block diagram showing system participants and process flow for advertising and security in an embodiment of the present invention.

Following are examples of how embodiments of the present invention can be used.

### 1. Communications to Other Users in Physical or Virtual Proximity

Using positioning, collision detection, and other means to track users, the invention determines a) who's device is where, b) who is generating and exchanging what germs, and c) what content is passed to whom. Every user in proximity should catch the germ as a result of being exposed, but who opens it and thereby is infected by it, is a different question. Embodiments include a variable number of algorithms and rules that control acceptance, storage, and propagation of the user's or a private community's pathology.
OS of the peers and intermediaries
Current embodiment Peer/Server/Group (Peers in proximity) PSP N # of algorithms and rules about acceptance, storage, and propagation of the user's pathology
   For example in a one to many usage
OUT TO THE INTERNET FEATURE OPTION FOR ANY USER in an attempt to go viral, also known as pandemic to the world
Proximity is determined in two levels (between peer radii and targeted peer arrivals—notify, or tighter radius arrivals at locations—also what appears to be visible (per the Omega patent pending separate application feature).
Participation

### Profile Preferences Examples

Set immunity
−1 to −10
Set contagion
+1 to +10

### Set Taste in News/Information

Alternative vs. Mainstream

### Set Gender

Boy vs. Girl.

### Set Age or Age Group:

Older vs. Younger

### Set Sexual Orientation

Gay vs. Straight

### Set Political Orientation

Left vs. Right

### Set Political Agenda

Moderate vs. Extreme
Etc. (for genres, ambitions, interests, backgrounds, etc.)

### Rate a Germ

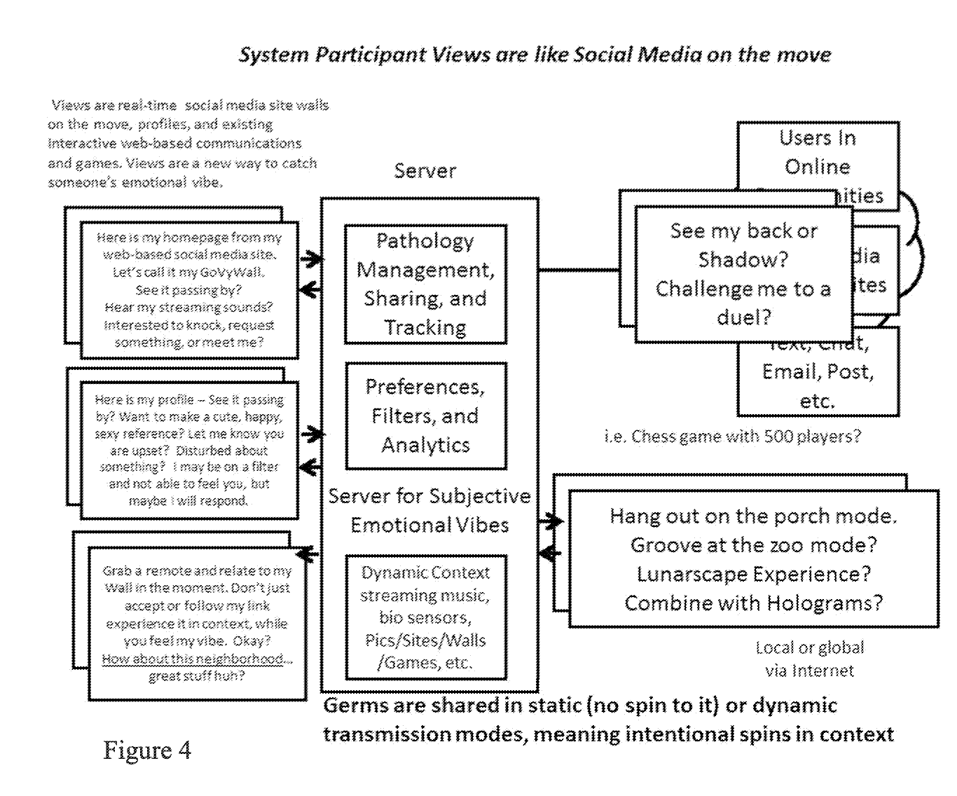

The semantic rules and behavioral algorithmic filtering features are meant to mature and include emotional state considerations, nostalgic feelings about past eras, time spent in various moods, contextual content associations, etc. (see FIG. 4 illustrating emotional spins on information).

The germs will also become self-learning to the point (ironically) where the system could suggest a list of nearby friends, rather than need a friends' list from users, in order to function efficiently.

All germs can be routed and posted to the internet at will, or by assigned site locations, which add to the possibility and viability of the germ content going viral.

### 2. Local Informing/Advertising/Marketing

Embodiments of the invention include a flexible mechanism, whereby a variable number of algorithms and rules about acceptance, storage, and propagation of an individual germ, or collectively, the user's pathology are of use to advertisers, agencies, statisticians, pollsters, etc. Advertising revenue drives much of the internet commerce, and embodiments of the present invention will make that situation less two-dimensional, and more multi-dimensional as germs of commercial offerings are on the move, and circulated in the three-dimensional world.

For example, in some embodiments with a one-to-many utilization, a user's pathology has a nearby merchant offering germ that appears and disappears when

1) the time (noon to 7 pm) and date (Feb. 22, 2013) elapses,
2) the location changes (Greenwich Village restaurant germ disappeared above 14^{th} Street),
3) the situation changes (Eric Clapton impromptu at the Village Gate is too full), etc.

Also, in embodiments merchants can buy preferences, events, and history pertaining to client users that are in proximity to better induce the merchants to provide products and services that would be in demand, or even trending at the moment.

The viral spreading of such ads and offers can turn each client-user into a virtual sandwich sign, for those who elect to do so, and the invention has the ability to know who may be entitled to commissions on bringing a consumer into a business location, or even a commission on the resulting sale itself.

In embodiments, the present invention can function as a virtual billboard that distributes user-independent postings of content as fixed location germs that a passerby user will pick up off of the server that has the merchant's advertisement location, which exchanges the germ with nearby, or otherwise important users.

### 3. Group Communications and Security—Private User Group Communities and Ad Hoc (Affiliate at Will) Group.

Embodiments of the invention allow a user to advise the server if he/she is in a user group at the time of enrollment. Then, in addition to all local functionality, the germ exchange happens with the other members of the user group. Running a business from a mobile device is not easy, and dissemination of important data to a business group of associates can help organize and synchronize a team's activities, for things like operations, sales, projects, etc. Groups of professionals, families, hobbyists, teenage enthusiasts, etc. can all benefit from embodiments of the present invention regardless of where they are geographically located.

Embodiments of the invention allow for messaging flexibility, similar to expensive security implementations, but without the cost of local servers and infrastructure, which can be complimentary but are not necessary to the present invention. A “hive mentality” forms and develops, waxes and wanes. In embodiments, the apparatus of the present invention also knows the locations of members of a group up to the accuracy of the location technology that is employed for location detection, some of which are capable of determining a user's location to within 3 feet. The utility of spreading germs to a specific person, or groups of persons, in proximity or anywhere the server can reach them, makes mobile devices of more value in managing teams, partnerships, firms, companies, first responders, security personnel, etc.

When enrolling in various embodiments, questions about a possible group affiliation are asked, and the administrative software sets up the germ-sharing as synchronized group pathologies and updates. Photos, music and videos can be quickly shared, and suspicious objects and people can be tagged as such. Streaming media can be synchronized to all in the virtual boom box, and virtual theater features in various embodiments under the heading of group communications and experiences and security.

In embodiments, modes of operation include:
Communications between local clients in proximity according to preset and movable radii, and/or how visible the client becomes, meaning a premium feature is to have commercial or public service appear larger to be included when outside the radius;
Communications from a local client-user to regional client-users;
Communications from a local client-user to internet or other networks/intranets;
Communications between private communities called colonies;
Communications between public communities called colonies; and
Other embodiments as technologies improve, innovations are implemented, and additional utilizations are discovered.

In embodiments, the invention's content mechanism can accommodate almost any type of anonymous information, including but not limited to texts, chats, URL links, pictures, news items, and all types of attachments. Some embodiments also offer synchronized streaming of germs regardless of where a user is, in relation to other users, so they can all enjoy the experience apart, as if they were together, and as if they were in a user group.

In one of its simplest embodiments, the present invention comprises two mobile communications devices and a mediating server that receives, analyzes, filters, and forwards messages from one mobile user to the other and back again.

The server is normally set up with anti-virus detection and natural-language understanding, and then applies a variable number of rules and algorithms governing acceptable content. Rules sometimes have embedded algorithms to better-detect and self-adjust for anomalies, such as the RETE algorithm used in most rules engines.

This feature can provide desirability, safety, and preferences of content, which enable a client user to receive and pass on germs that are both safe and likely appropriate to each client-user who takes the time to set said preferences, and/or report any abuses.

In embodiments, the present invention's location-based features employ positioning technologies, such as GPS, and frequency detection of wide-band signal strength such as GSM 900/1800 (MHz) for USA, GSM 850/1900 (MHz) for the rest of the world, CDMA for USA, EDGE network, other 3G and 4G types of networks. The apparatus will incorporate other positioning technologies and systems as they become practical and available.

Embodiments also use collision detection algorithms, such as the ones disclosed in co-pending U.S. patent application Ser. No. 14/180,568, to determine the identities of client users, and where they are located in relation to other client users.

Various embodiments can also include other devices that are location-based, often using maps to show locations and advertisers of offers, giving users of these systems additional ways to communicate via their possible integration with the within invention.

Following are examples of some details of embodiments of the present invention:

### Events

E1. Propagation: User B propagates a Germ to User A (how doesn't matter, i.e. proximity is irrelevant)

E2. Polling: User A polls the server to refresh his Pathology, providing:
E2A. The maximum number of germs he wants in his Pathology (based on user preferences, also possible to say “infinite” number of germs)
E2B. How many new germs he wants to be added to his Pathology (again, preference-based and possible to say “as many as are available”
E2C. His chosen personality (i.e. “mainstream”, “mid-stream”, or “alternative, but more classifications and more complex definitions are possible)

### Rules

Upon Propagation:

R1. Server Copies the Germ's ID into User A's “Pache” (pathology cache)

R2. Server determines if the pache has grown too big (an internal determination, not necessarily based on user preferences)

If so, the Server removes some germs based on an internal or user-defined rule-set (i.e. oldest germs are deleted first or based on user's Personality setting)

### Upon Polling:

P1. Server determines if any germs should be moved from the Pache into the Pathology

If so, Server uses statistical weighting (described below) to determine which germs should be moved, and moves them. 2. Server sends the (possibly updated) list of germs in his Pathology to User A

Weighting Algorithm:

A1. Each Germ is tracked for two pieces of information about it
A1A. How many users have contracted the Germ (not necessarily viewed it)
A1B. How many users have actually viewed the Germ
A1C. How many users, at any given time, have flagged the Germ as contagious (and thus are transmitting it to others)

A2. Using some equation that utilizes this information, a weight is assigned to the Germ
A2A. Currently, Value C is used as the Germ's weight because it directly implies how popular the germ is (how “mainstream”)

A3. This weighting is done to all the germs and the result is a list of germs each with a value representing its popularity

A4. At the same time, the total number of germs, and the total of all the Germ weights are calculated

A5. The values of #2, #3, and #4 are used as the input to a biased probabilistic determiner which provides a random sample of the germs but is biased in favor of, or against, each Germ's popularity (depending on the Personality setting of User A)

A6. Current Embodiment Algorithm Examples

Each Personality uses a slightly different algorithm. It's easier to understand if I describe them separately.
A6A. Mainstream Algorithm:

```
i = 1
X = 0
While (i <= N)
  X += W[i]
  If R < X
    G[i] is the germ to use
  End-If
  i = i + 1
End-While
L = A list of germs (in this case, the germs in the Pache )
N = Total count of germs in L
G[i] = The germ at position i in L (i is always <= N)
W[i] = The Weight of the germ at position i in L
R = A random number between 1 and T
X = An accumulator that holds the total Weight of all germs as each is processed (a running total)
T = Total Weight of all germs
```

This algorithm implements a virtual roulette wheel-like device with varied slot sizes where the wider the slot, the more likely the ball lands in it.
A6B Mid-stream Algorithm

This one is really just pick a random germ, the user doesn't care if it's popular or not
A6C Alternative Algorithm

This is the inverse of the mainstream. It just uses the popularity as a negative bias

L=A list of germs (in this case, the germs in the Pache)
N=Total count of germs in L
G[i]=The Germ at position i in L (i is always <=N)
W[i]=The Weight of the germ at position i in L
R=A random number between 1 and T
X=An accumulator that holds the total Weight of all germs as each is processed (a running total)
M=The maximum Weight of any germ in L
m=The minimum Weight of any germ in L
T=Total Weight of all germs, offset by (M+m)

To calculate T:

```
i = 1
O = M + m
While (i <= N)
  T = T + O − W[i]
  i = i + 1
End-While
```

Then the modified mainstream algorithm

```
i = 1
X = 0
While (i <= N)
  X += O − W[i]
  If R < X
    G[i] is the germ to use
  End-If
  i = i + 1
End-While
```

In the above example, one of these algorithms (or others as they are appropriate and efficient), is executed for each new germ required, as specified in Event 2 when the user is polled. Which algorithm to use is determined by the personality setting (also specified in Event 2).

### 4. As a Mobile App Add-on for Search Engines

Embodiments of the invention include a dynamic mobile device application that enables a quick handoff exchange of pre-filtered, likely interesting germs from users passing by other users, with no restrictive friends list, professional affiliations, group associations, etc. required.

If a new blog or website is posted, traditionally cross media attention, and search engine optimization techniques can be employed, and because that is difficult, expensive, and often inefficient, most new content posted on the internet goes relatively or completely unnoticed. Twitter and Facebook improve the chances of learning news and content, but are one-to-many systems that rely on relationships that are geographically unrelated.

The present invention in embodiments is a system with users that are constantly on the move, to discretely generate, discover, search, find, and share info using computing devices such as smartphones already in use by consumers (members, merchants, and others) in proximity. These embodiments are therefore an adjunct to cross-media and search engines, because they actively disseminate links and other info about that site, which then has hundreds or even thousands of channels to spread, or even go viral. Thus, new blog content is made know by an active search, rather than a static one.

Embodiments of the present invention enable geographically-targeted messaging and advertising capabilities:
spread and catch a germ (packet of information, like tweets, YouTube links, chats, text, pics, etc.)
generate a germ about your blog, charity, family, Facebook page—most anything you care about, and wish to share
selectively pass it on, and go viral in a highly contagious and auto-spreading manner.
while on the move as you walk or ride around the town or neighborhood, you receive germs in your pathology (germ list)
you may wish to activate them too, and spread the combined germs to other users nearby (a friends list is optional and not necessary)
you may have pre-approved this type of germ to be passed without any further individual user actions
then, because the handoff exchange continues, contagious, truly viral-like results can happen in a way that posting a video one-time on the internet cannot as easily accomplish
germs you choose to save in your pathology, can be archived, and get fed to search engines on the internet, along with statistics and location demographics, making the within invention a dynamic add-on to show trending and other behaviors as they develop
the invention is like the quiz show Jeopardy, where you have to formulate the question after being given the answer.
meaning, it resembles a reverse search engine where the appropriate answers and information find the right people with the right queries.
paid germs can expand to multiple specific locations, like 57 military bases could see your local offer to help military kids go to summer camp, or a notice that disabled soldiers, about to be discharged, get scholarships (as examples).
paid germs can be posted like virtual billboards to regional, national, or global sites and users who choose to receive out-of-area news, offers, and advertising, the way expatriates seek news from their original country.

Embodiments of the present invention raise the bar on search engine technology, since they act as a dynamic mobile device engines—as add-ons to existing internet search engines. Both work with paid and non-paid results. This method and apparatus can be used by consumers, advertisers, event organizers, safety personnel, administrators, public safety officials, etc. as the local (missing) component of a web-based search engine, and make it far more relevant in our day-to-day lives.

Neighborhoods in cities, towns, rural villages, and/or remote regions, where an embodiment of the invention is well-utilized, can take on characteristics and feelings within the germs passed there, whereby a connected search engine can evolve to take on a local presence, significance, and character based on the demographic, social, and commercial knowledge of what is included in the collective pathologies of the region.

The present invention can also be a dynamic add-on or integrated feature, to complement conventional web search experiences, in which the search engine of choice can influence, and participate with users more proactively, and in real-time, allowing a more dynamic communication flow of information to take place. Rather, like a reverse search engine, message germs of information search and find appropriate waiting and willing recipients. In this regard the germs act as agents, intelligent agents, rational intelligent agents, and/or independent rational intelligent agents with the appropriate characteristics associated with that type of artificial intelligence object.

The present invention is more faithfully viral in nature than the prior art, disseminating user messages, herein referred to as “germs,” in a contagious manner, like certain diseases or computer malware. In embodiments that are specifically designed to better share and spread content, the device server filters and swaps the germs of two users in close proximity, or with pre-registered user groups, private communities, or to the internet, and constantly re-sends those to different locations, at different times, and to different, willing and waiting recipients, just by a system user walking around, or driving down the street and coming in proximity to another system user they likely do not know. This device is used for messaging and streaming communications in the social media, advertising, and security industry sectors, and all future utilizations which are claimed herein, and does not require anonymous client-users to expose their identities, know each other, and/or be on friend's lists.

Other promotional methodologies are included in the scope of the present invention, whereby automatic phone calling machines vote over and over for favorite contestants. This mechanized expression of favoritism, if not outright cheating, is similar in that it is like a symbol of hope calling and re-calling about your content in specific places, over and over, which has a far better chance to bring attention to the content it wishes to spread.

In the radio world, a local station in Cleveland, for example, can broadcast an artist's new song, and the phone lines light up with callers requesting to hear it again, indicating the song is popular in that locale. Local merchants may then sell recorded hard copies, or file downloads and trade magazines tell the global industry a hit is born in that place.

In a similar way, embodiments of the present invention can leave virtual germs in Cleveland (for example) about a new artist, product, website, etc., and the likelihood of the information spreading and the possibility of going viral are greatly increased. So if a new blog is posted or updated, in addition to cross-media attention and search engine optimization, the virtual billboard information provided by embodiments of the present invention, repeatedly sent and received inside pathologies there, can become a conduit for the information to get attention, and become commercially successful in a specific location that is well suited for the content.

One embodiment of the client server-based process is:

Step 1: Member chooses to use the app by download, once, twice, multiple times, or on a more permanent basis.

Step 2: Member can enroll in the services, with little information, such as preferring mainstream and conservative political germs to alternative and liberal political germs.

Step 3: Adding optional personal information and preferences to whatever degree the member desires, will set more filters, agents, analytics, and semantics, to work in the engine, which will catch selected germs, becoming infected, allow presentation for user rating and retransmitting of the endorsed germ, or modified germ, which is a more selective and automated process. Reporting abuses is important too.

Step 4: The app is initialized or if the setting is selected, is powered on more permanently when the Smartphone or other mobile device is powered up, at all times.

Step 5: Initializing gets the user located on the grid.

Step 6: Germs can be passed when users are visible to each other, meaning they are in a given proximity, which is an adjustable boundary like radii as a simple example, or they are otherwise known, or visible to another user, by a multitude of technologies including the technology disclosed in related patent application #61/764,673.

Step 7: An exchange takes place by means of a file swap on the server, which adds and deletes germs in the mobile device user's pathology (which is a list of germs caught and able to be endorsed, modified, passed on, retained, archived, etc.).

Step 8: To manage large amounts of data, spam, trolling and other undesirable information to exchange, the embodiments make use of user set and system inferred preference lists, rules, and filtering algorithms, all of which can be applied according to the receiving customer's criteria and tastes.

Step 9: Germs can stay until deleted from the server file/pathology, or simply disappear if not endorsed or modified. The server has the ability to make germs appear, disappear, and reappear for a host of reasons and utilizations.

Step 10: Limits on #s of germs retained and transmitted can be set based on location traffic.

Step 11: Server files or database tables have the information of which content was generated, endorsed, and retransmitted, by whom, to whom, when, and where. This tracking enables the paying of rewards or commissions for commercial content, tracking movements for law enforcement, and multiple other reasons.

Step 12: For integration with other devices, the germ data and actions like selecting, archiving, re-appearing, and tracking of germ content, is the apparatus interface as it is a data exchange with other technologies. That is how search engines and social media sites, promoting the germ content can place it at the top of the search engine results, news feeds, popular video lists, etc.

### OTHER FEATURES AND BENEFITS OF VARIOUS EMBODIMENTS

In embodiments, statistics involving contagions are collected and reported, such as how many retransmissions, how often, which hours, etc., enabling commercial users to know how to maximize their use of the invention. These can be highly valuable data to those mounting awareness campaigns for events, polls, causes, products, and services.

Embodiments of the present invention create the opportunity for an almost infinite number of variations in utilizations, such as virtual billboards. Multiple locations can be the simultaneous places for short or long germ visibility periods of times, like virtual billboards, where they matter to the administrator, security person, advertiser, etc. For example, posting within a 3 mile radius of 57 domestic US military bases narrows the audience focus for offer effectiveness, and advertisers' competition for users' attention, transforming global challenges into a local matter, or in this case, a multi-location matter when someone wants to solicit military personnel that are in these locations. This targeted approach reduces or eliminates the need for general advertising that reaches more places and people than would want such an offering.

Embodiments of the present invention provide superior auto-viral capability based on constantly retrying to promote the same material in different locations at different times.

When a user builds a website or posts to a blog, Facebook, YouTube, etc. almost no one will notice, and timing is everything.

The constant retransmitting of a germ that describes and links to a video, as an example, will typically bring in a larger audience; hundreds, maybe thousands, maybe millions will know, in a dynamic, more automated one-to-one and one-to-many distribution system, that is included in embodiments of this invention by proximity, visibility, user group relationships, networks, and the internet. Thus embodiments of the present invention can function as virtual extensions to search engines, reversing the search process, as the information reaches out to find client users.

In embodiments, the semantic rules filtering feature in combination with a mobile device messaging system reduces or eliminates the need for a friends' or members' lists, based on a variable number of rules and criteria applied to the information.

Embodiments include messaging without friends' or members' lists for each user.

In embodiments, which client users receive which germs and advertising offerings is also determined in that layer, better enabling the merchant's offering information to reach out to find receptive users. This is made possible by the method in which embodiments handle the problems associated with big data, while real-time use of filtering technologies is difficult, because the process is slow and in real-time systems, such as embodiments of the present invention, filtering needs to be virtually instantaneous.

In embodiments, combining semantic rules, taxonomies, ontologies, algorithms, preference settings, and other decision support technologies, to appropriately filter messages being exchanged, eliminates the main need in social media and other communications systems for friend's lists, professional associations, group memberships, introductions and acceptances, vouching and endorsing proposed members, etc.

In some virtual sandwich sign embodiments, the transfer of the first user's advertising germ is responsible for the second user's visit to the advertiser's premises, which can be determined in embodiments by the location-based capabilities of the invention in combination with germ tracking capabilities. This feature allows a user to act, and perhaps be compensated, as an anonymous and willing salesperson who is wearing a virtual sandwich sign. Other location-based advertising applications, such as Foursquare, have no built in capabilities for a single referral reward system, or multiple referral reward systems, viral or not.

Embodiments include ad hoc and preplanned user group security services, whereby any user can form and dissolve user groups in communication for events and all types of gatherings.

Virtual boom box and virtual theater embodiments are included in the present invention, whereby users request and the server provides music, videos, films, readings, lessons, courses etc. to those nearby, or visible, and/or in a private community. Sharing can also be synchronized, whereby the invention can stream content like music, lessons, or videos to multiple users who had or had not previously known each other, like a virtual boom box.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

I claim:

1. A software implemented method for distributing and sharing information between peers, the method comprising:
selecting a first group of peers to a first client user;
enabling the first client user to transmit an item of information to the first group of peers using a computing device, the item of information being herein referred to as a “germ;”
enabling said first group of peers to resend the germ using computing devices to at least one second group of peers; and
logging the transmitting and resending of the germ.

2. The method of claim 1, wherein the first group of peers is selected from among peers that are physically or virtually proximal to at least one location, the at least one location being at least one of a location of the first client user and at least one predetermined location.

3. The method of claim 1, wherein at least one of the first group of peers and the second group of peers is manually selected by a client user or by a private community administrator who invites users to join the first group of peers or the second group of peers, where said user can accept or reject the invitation.

4. The method of claim 1, wherein the first group of peers is selected from among peers in attendance at a multi-participant event, the germ including content that is able to enhance at least one of enjoyment and security of the peers in attendance at the multi-participant event.

5. The method of claim 1, wherein selecting the first group of peers includes using at least one of a mainstream vs. alternative lifestyle algorithm, a behavior algorithm, an internally selected business rule, a rule that is externally input, an automated artificial intelligence algorithm, semantic data analysis, a taxonomy, and an ontology.

6. The method of claim 1, wherein the germ is filtered before it is resent, said filtering including at least one of manual filtering, physical or virtual proximity filtering, application of a mainstream vs. alternative lifestyle algorithm, application of a behavior algorithm, application of an internally selected business rule, application of a rule that is externally input, application of an automated artificial intelligence algorithm, application of semantic data analysis, application of a taxonomy, application of a preference list specified by a client user, and application of an ontology.

7. The method of claim 1, wherein the germ is resent automatically to other peers.

8. The method of claim 1, further comprising:
if the transmitting and resending of the germ accomplishes a desired result, whereby advertisers provide a reward the first resender, and/or to a chain of client users involved in the transmitting and resending of the germ.

9. The method of claim 8, wherein the desired result is that a recipient of the germ makes a purchase from a specified merchant, and the reward includes at least one of:
a fixed fee paid by the merchant and shared among the chain of client users;
a merchandise credit issued by the merchant and shared among the chain of client users;
a percentage commission calculated based on a purchase price of the purchase, paid by the merchant, and shared by the chain of client users involved in transmitting the germ; and
a merchandise discount offer distributed by the merchant to the chain of client users.

10. The method of claim 1, wherein the germ is transmitted at least partly via a network.

11. The method of claim 1, wherein the germ is resent manually.

12. The method of claim 1, wherein the germ is resent automatically.

13. The method of claim 1, wherein the germ is transmitted in an encrypted form that can be decrypted by peers on local devices.

14. The method of claim 1, wherein at least one of the germ transmissions and resending is anonymous.

15. A software implemented method for distributing and sharing information between peers, the method comprising:
automatically selecting a first group of peers to a first client user;
enabling the first client user to disseminate an item of information to the first group of peers using a computing device, the item of information being herein referred to as a “germ;” and
enabling said first group of peers to automatically resend the germ using computing devices to at least one second group of peers without user intervention, thereby distributing the germ among groups of peers in a contagious, viral manner.

16. The method of claim 15, wherein the first group of peers is selected from among peers that are physically or virtually proximal to the first client user.

17. The method of claim 15, wherein selecting the first group of peers includes using at least one of a mainstream vs. alternative lifestyle algorithm, a behavior algorithm, an internally selected business rule, a rule that is externally input, an automated artificial intelligence algorithm, semantic data analysis, a taxonomy, and an ontology.

18. The method of claim 15, wherein the germ is filtered before it is resent, said filtering including at least one of physical or virtual proximity filtering, application of a mainstream vs. alternative lifestyle algorithm, application of a behavior algorithm, application of an internally selected business rule, application of a rule that is externally input, application of an automated artificial intelligence algorithm, application of semantic data analysis, application of a taxonomy, application of a preference list specified by a client user, and application of an ontology.

19. The method of claim 15, wherein the first group of peers is selected from among peers in attendance at a multi-participant event, the germ including content that is able to enhance at least one of enjoyment and security of the peers in attendance at the multi-participant event.

20. The method of claim 15, further comprising:
logging the transmitting and resending of the germ; and
if the transmitting and resending of the germ accomplishes a desired result, providing a reward to at least one of the first client user, a first resender, a last resender, and an entire chain of client users involved in the resending of the germ.

21. The method of claim 15, wherein the germ is transmitted at least partly via a network.

22. The method of claim 15, wherein the germ is transmitted in an encrypted form that can be decrypted by peers on local devices.

23. The method of claim 15, wherein at least one of the germ transmissions and resendings is anonymous.

24. A software implemented method for distributing and sharing information between peers, the method comprising:
selecting a first group of peers to a first client user;
enabling the first client user to transmit an item of information to the first group of peers using a computing device, the item of information being herein referred to as a “germ,” said first group of peers; and
enabling said first group of peers to resend the germ using computing devices to at least one second group of peers, said second group of peers not being limited to pre-defined lists of peers.
